(19) United States
(12) Patent Application Publication
(10) Pub. No.: US 2013/0233890 A1
(43) Pub. Date: Sep. 12, 2013

(54) FILTER FOR A BEVERAGE DISPENSER

(71) Applicant: Brian MELZER, Delray Beach, FL (US)

(72) Inventor: Brian MELZER, Delray Beach, FL (US)

(21) Appl. No.: 13/416,194

(22) Filed: Mar. 9, 2012

(51) Int. Cl. B67D 7/76; C02F 1/00; B67D 7/06

(52) U.S. Cl. 222/189.06; 210/172.1; 222/185.1

(57) ABSTRACT

Dispenser filters are provided that can be used in beverage systems to filter a beverage to be outputted from a beverage source (e.g., a vessel or a container) by a beverage dispenser. The dispenser filters can define an interior cavity that is in fluid communication with a beverage source, and can be configured to permit fluid to flow from the beverage source into the interior cavity, while inhibiting at least some objects (e.g., pieces of food) in the beverage from flowing into the interior cavity. The dispenser filter can include an outlet configured to discharge the beverage collected within the interior cavity.

### TECHNICAL FIELD

Exemplary embodiments of the present disclosure are directed to a filter, and more particularly, to a filter for a beverage dispenser.

### BACKGROUND

Beverage dispensers are widely used to dispense a beverage to a user. One type of a beverage dispenser includes a large vessel filled with a beverage and a spigot disposed toward a bottom of the vessel for dispensing the beverage. This type of beverage dispenser can be referred to as a gravity feed beverage dispenser because the beverage is dispensed from the vessel under the force of gravity. The vessel often includes fruit, berries, vegetables, spices, or other objects, such as ice, mixed with the beverage. For example, the vessel could be filled with sangria, which typically includes slices of fruit mixed with wine.

As the beverage is dispensed form the beverage dispenser, the fruit, berries vegetables, or other objects are drawn into the opening of the spigot and can clog the spigot such that the flow of the beverage out of the vessel through the spigot is interrupted or impeded. For example, it is not uncommon for the pieces of fruit to become lodge in the flow path of the spigot. Such clogs typically require insertion of a long mixing tool into the beverage in an attempt to dislodge the obstruction and restore the flow. In a worse case, the beverage must be displaced into another vessel so that the user can manually remove the clog. Such clogs can be an inconvenience and a burden to users of conventional beverage dispensers, and may dissuade users from using the beverage dispensers.

### SUMMARY

Exemplary embodiments of the present disclosure are directed to dispenser spigot filters configured to mate with dispenser spigots and to filter fluid from a source to be outputted by the dispenser spigot. Exemplary embodiments of the dispenser filters can define an interior cavity that is in fluid communication with a fluid source, and can be configured to permit fluid to flow from the fluid source into the interior cavity while inhibiting at least some objects from flowing into the interior cavity. The dispenser filter can include an outlet configured to discharge the fluid collected within the interior cavity.

In one embodiment, a dispenser filter is disclosed. The dispenser filter has a body including a beverage filtering portion and a dispenser connector portion, and defines an interior cavity. The interior cavity of the body is in fluid communication with a beverage source through the beverage filtering portion. The beverage filtering portion permits a beverage to flow into the interior cavity from the beverage source and inhibits objects in the beverage from flowing into the interior cavity. The dispenser connector portion mates with a dispenser spigot to place the interior cavity in fluid communication with the dispenser spigot to discharge the beverage from the interior cavity of the body.

In another embodiment, a beverage dispensing system is disclosed. The system includes a beverage source, a dispenser, and a dispenser filter. The beverage source has an interior area configured to contain a beverage. The dispenser is configured to dispense the beverage from the beverage source. The dispenser filter is disposed in the interior area of the beverage source and mates with the dispenser. The dispenser filter has an interior cavity in fluid communication with the interior area of the beverage source to collect the beverage in the interior cavity. The dispenser filter has an outlet in fluid communication with the dispenser to discharge the beverage from the interior cavity of the dispenser filter.

In yet another embodiment, a method of filtering a beverage being dispensed from a beverage container is disclosed. The method comprises mating a dispenser filter with a dispenser spigot in an interior area of a beverage source configured to contain a beverage. The dispenser filter has an interior cavity in fluid communication with the interior area of the beverage source and that is in fluid communication with the dispenser spigot. The method also includes filling the interior of the beverage source with a beverage, collecting the beverage in the interior cavity of the spigot dispenser filter, inhibiting objects in the beverage from passing from the interior area to the interior cavity, and dispensing the beverage collected in the interior cavity through an outlet spout of the spigot dispenser filter.

In still another embodiment, a dispenser assembly for a beverage dispensing system is disclosed. The dispenser assembly includes a dispenser spigot section and a beverage filtering section. The dispenser spigot section has an actuating member and an outlet spout. The beverage filtering section has a body that defines an interior cavity. The body includes apertures and the interior cavity is in fluid communication with a beverage source through the apertures to permit a beverage of the beverage source to flow through the apertures into the interior cavity and to inhibit objects in the beverage from flowing into the interior cavity. The beverage filtering section is integrally formed with the dispenser spigot and the actuating member is moveable to selectively dispense the beverage from the interior cavity of the beverage filtering section.

In yet another embodiment, a kit is disclosed. The kit includes a container, a dispenser spigot, and a dispenser filter. The container defines an interior area. The dispenser spigot is configured to be in fluid communication with the interior area. The dispenser filter is configured to be disposed in the interior area of the container and secured to the dispenser spigot. The dispenser filter has a body that defines an interior cavity to be in fluid communication with the interior area of the container, to permit a beverage in the interior area to flow into the interior cavity, to inhibit objects in the beverage from flowing into the interior cavity, and to discharge the beverage from the interior cavity through the dispenser spigot.

Exemplary embodiments of the present disclosure minimize and/or eliminate undesirable clogging of a beverage dispenser due to objects in the beverage being drawn into the beverage dispenser when the beverage is being dispensed. Exemplary embodiments prevent the objects in the beverage from reaching a inlet of the dispenser so that a fluid flow through the dispenser is not interrupted and/or impeded.

### BRIEF DESCRIPTION OF THE DRAWINGS

The foregoing and other features and advantages provided by the present disclosure will be more fully understood from the following description of exemplary embodiments when read together with the accompanying drawings.

FIG. 1 is a perspective view of an exemplary dispenser filter.

FIG. 2 is a side view of the dispenser filter of FIG. 1.

FIG. 3 is distal end view of the dispenser filter of FIG. 1.

FIG. 4 is a perspective view showing another exemplary embodiment of a dispenser filter.

FIG. 5 is a cross-sectional side view of the dispenser filter of FIG. 1.

FIG. 6 is a perspective view of an exemplary beverage dispensing system.

FIG. 7 is a partially exploded side view of the beverage dispensing system of FIG. 6.

FIG. 8 is a perspective view of an exemplary assembly of an unitary dispenser and dispenser filter.

FIG. 9 is a side view showing another exemplary embodiment of a dispenser filter having a bulbous shape.

FIG. 10 is a perspective view showing another exemplary embodiment of a dispenser filter having a rectangular shape.

FIG. 11 is a perspective view showing another exemplary embodiment of a dispenser filter having a ring shape.

FIG. 12 is a perspective view showing another exemplary embodiment of a dispenser with a tip portion devoid of apertures.

FIG. 13 is a side view showing another exemplary embodiment of a dispenser filter that is devoid of a transition portion.

FIG. 14 is a side view showing another exemplary embodiment of a dispenser filter that is devoid of a transition portion.

### DESCRIPTION OF EXEMPLARY EMBODIMENTS

Exemplary embodiments of the present disclosure are directed to a dispenser filter configured to filter a beverage contained in a beverage source (e.g., a vessel or a container) of a beverage dispenser. The dispenser filter can include an interior cavity that is in fluid communication with a beverage source, and can be configured to permit a beverage to flow from the beverage source into the interior cavity while inhibiting at least some objects (e.g., pieces of food) in the beverage from flowing into the interior cavity. The dispenser filter can include an outlet configured to discharge the beverage collected within the interior cavity.

Exemplary embodiments of the present disclosure can reduce or eliminate clogs that interrupt or impede an output of a beverage that includes pieces of food (e.g., fruit, vegetables, and spice) contained in a beverage dispenser. By including the dispenser filter between a beverage source and a dispenser spigot, the beverage flows from the beverage source to the dispenser spigot through the dispenser filter. The dispenser filter can prevent objects that could potentially clog the beverage dispenser from flowing to the dispenser spigot. For example, in exemplary embodiments, the dispenser filter can include apertures that can be sized to permit the beverage to flow into the filter, but can inhibit or minimize objects in the beverage from flowing into the filter.

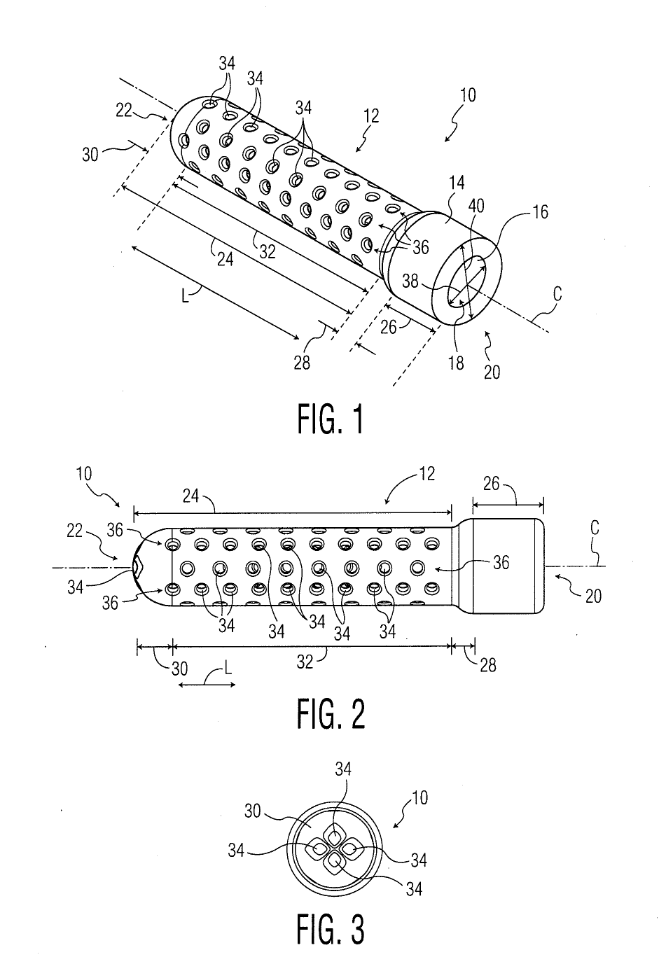

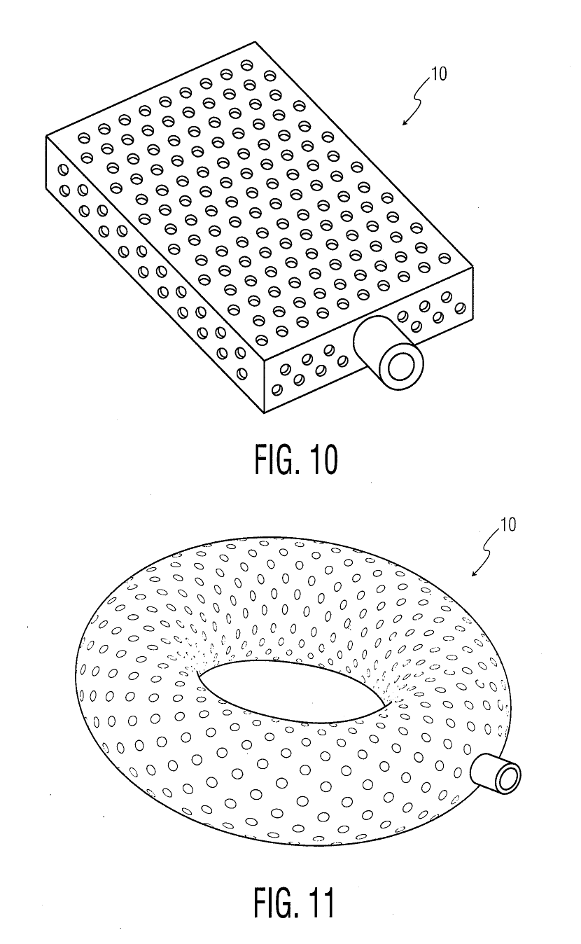

FIGS. 1-3 show an exemplary embodiment of a dispenser spigot filter 10. The filter 10 can be formed from elastic, flexible, semi-rigid, and/or rigid materials. For example, the filter 10 can be formed from silicone, rubber, latex, plastic, and/or any other materials suitable for contacting comestibles. As shown in FIGS. 1 and 2, the filter 10 includes a body 12 having an outer surface 14 and an inner surface 16, and defines an interior cavity 18. The body 12 extends along a longitudinal axis L from a proximal end 20 to a distal end 22. The body 12 can include a beverage filtering portion 24, a dispenser connector portion 26, and a transition portion 28 positioned between the filtering portion 24 and the connector portion 26. The filtering portion 24 extends along the longitudinal axis L from the distal end 22 toward the transition portion 28 of the body 12. The connector portion 26 extends along the longitudinal axis L from the proximal end 20 to the transition portion 28. In the present embodiment, the body 12 can have a generally tubular or cylindrical shape with a center axis C. While the body 12 of the present embodiment is tubular or cylindrical, those skilled in the art will recognize that other shapes and/or configurations of the body 12 can be implemented. For example, in some embodiments, the body 12 of the filter 10 can have a generally bulbous shape (FIG. 9), rectangular shape (FIG. 10), ring shape (FIG. 11), and/or any other suitable shape.

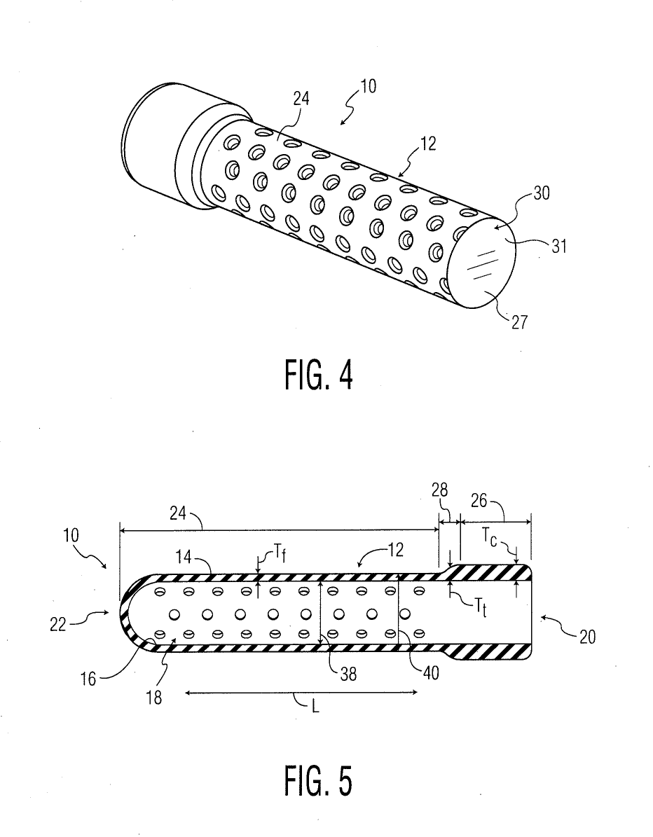

Referring still to FIGS. 1 and 2, a tip portion 30 of the filtering portion 24 can be formed at the distal end 22 of the body 12 and can have a generally rounded or bull-nose profile and/or configuration such that the tip portion 30 generally tapers radially inward toward a center axis C of the body 12 from an intermediate portion 31 to the distal end 22. In another embodiment, as shown in FIG. 4, the tip portion 30 can be truncated such that the tip portion 30 forms a wall 27 (e.g., a base of a cylinder) that extends substantially perpendicular to the filtering portion 24.

Referring now to FIGS. 2 and 3, the tip portion 30 can include one or more fluid communication portions, e.g., apertures 34, to facilitate fluid communication between the interior cavity 18 and an exterior of the body 12. The apertures 34 can form inlets of the filter 10 and can be dimension to permit fluid to pass through the apertures 34, but to limit, restrict, and/or prevent particulates from passing through the apertures 34. For example, the apertures 34 can be dimensioned to limit, restrict, and/or prevent food particles, such as pieces of fruit, vegetables, seeds from fruit or vegetables, and/or other food particles. The apertures 34 can form openings, such as holes, slits, slots, and/or any other suitable openings to facilitate fluid communication between the exterior and interior of the body 12.

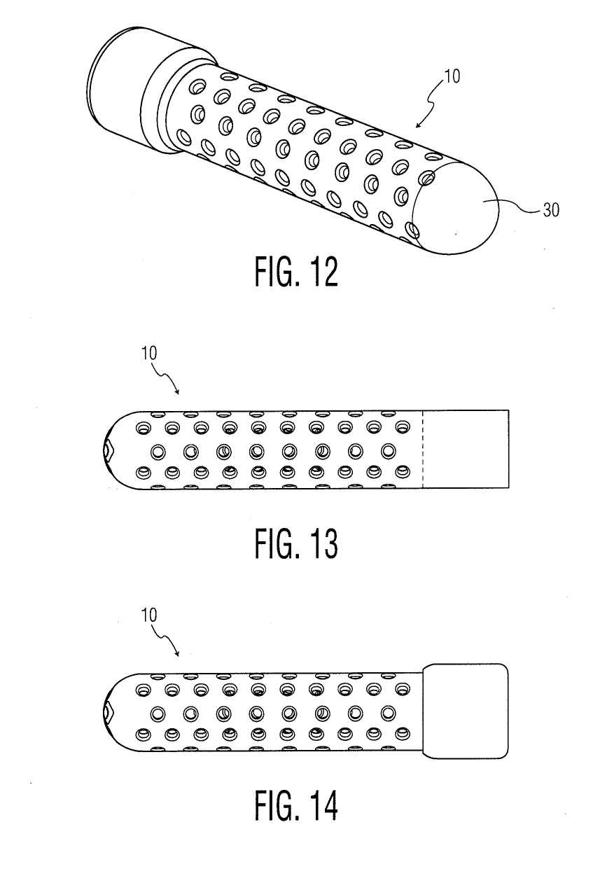

In some embodiments, the apertures 34 can be formed in a symmetrical pattern (as shown in FIG. 3) at the distal end 22 of the tip portion 30 and/or can extend between the tip portion 30 and a shaft portion 32 that extends from the intermediate portion 31 to the transition portion 28. While the tip portion 30 of the present embodiment includes fluid communication portions, those skilled in the art will recognize that the tip portion 30 can be formed without fluid communication portions to inhibit fluid communication between the interior cavity 18 and the exterior of the body through the tip portion 30 (FIG. 12).

The shaft portion 32 can have a generally uniform cylindrical shape disposed radially about the center axis C such that the radial distance from the center axis to the shaft portion 32 is generally constant. The shaft portion 32 can include fluid communication portions, e.g., the apertures 34, distributed about a circumference of the shaft portion 32. In some embodiments, the apertures 34 can be arranged in one or more patterns. For example, in the present embodiment, the apertures 34 can be arranged in a pattern with rows 36 that extend along the longitudinal axis L and that are formed about the circumference of the shaft portion 32. The apertures 34 that form a first one of the rows 36 can be offset from the apertures 34 of the rows 36 that are adjacent the first one of the rows 36 such that apertures 34 in adjacent rows are longitudinally offset (i.e., not radially aligned). Having radially offset apertures 34 can provide structural integrity to the shaft portion 32 to minimize or prevent the shaft portion 32 from collapsing under a load place on the shaft portion 32 during operation when the shaft portion 32 is formed from, for example, silicone. While the present embodiment illustrates an exemplary arrangement of the apertures 34, those skilled in the art will recognize that other arrangements of the apertures are possible.

The connector portion 26 can have a generally uniform cylindrical shape disposed radially about the center axis C and can include an outlet formed at the proximal end 20 of the body 12 to allow fluid in the interior cavity 18 to be discharged. The connector portion 26 can have an inner diameter 38 measured through the center axis C and across the inner surface 16, an outer diameter 40 measured through the center axis C and across the outer surface 14, and a thickness T_{c} (see FIG. 5) measured radially between the outer surface 14 and the inner surface 16. The thickness T_{c} can be generally uniform or can vary, and can be specified to provide structural integrity to the connector portion 26 to facilitate mating of the connector portion 26 to a dispenser spigot. In some embodiments, the connector portion 26 is configured to form a friction fit with a dispenser spigot. In some embodiments, the connector portion 26 can include interlocking members that mate with corresponding interlocking members of a dispenser spigot. For example, in some embodiments, the connector portion 22 can threadingly engage the dispenser spigot, form a snap fit with the dispenser spigot, or can be implemented using any other suitable mating techniques.

The transition portion 28 provides a transition between the filtering portion 24 and the connector portion 26. As shown in FIG. 2, the outer surface 14 of the body 12 in the transition portion 28 tapers radially inward toward the center axis from the connector portion 26 to the filtering portion 24. While the present embodiment is shown with the transition portion 28, those skilled in the art will recognize that in other embodiments the filtering portion 24 may interface with the connector portion 26 without a transition portion 28 (FIGS. 13 and 14).

As shown in FIG. 5, the inner diameter 38 can be generally constant in the connector portion 26 and the shaft portion 32 of the filtering portion 24, and the outer diameter 40 of the filtering portion 24, the connector portion 26, and the transition portion 28 can be different. The filtering portion 24 can have a thickness T_{f} measured radially between the outer surface 14 and the inner surface 16. The thickness T_{f} can be specified to provide structural support to the filtering portion 24 to minimize and/or prevent the filtering portion 24 from collapsing under an operation load applied to the filter 10 during use. In exemplary embodiments, the thickness T_{f} can be less than or substantially equal to the thickness T_{c} of the connector portion 26 (T_{f}≦T_{c}). For example, in the present embodiment, the filtering portion 24 is at least half as thick as the connector portion 26 (T_{f}≦½(T_{c})). In exemplary embodiments, the thickness T_{c} can be greater than the thickness T_{f} to provide the connector portion 26 with a greater elastic contraction force so that the connector portion 26 contracts around a portion of a dispenser spigot.

A thickness Tₜ of the transition area 24 is measured radially between the outer surface 14 and the inner surface 16. The thickness Tₜ can increase through the transition portion 28 from the filtering portion 24 to the connector portion 26. In exemplary embodiments, the thickness Tₜ of the transition portion 28 can provide a reinforced interface between the filtering portion 24 and the connector portion 26 to reduce wear and tear on the filter 10 at the interface between the filtering portion 24 and the connector portion 26 from repeatedly engaging and disengaging the filter 10 with a dispenser spigot.

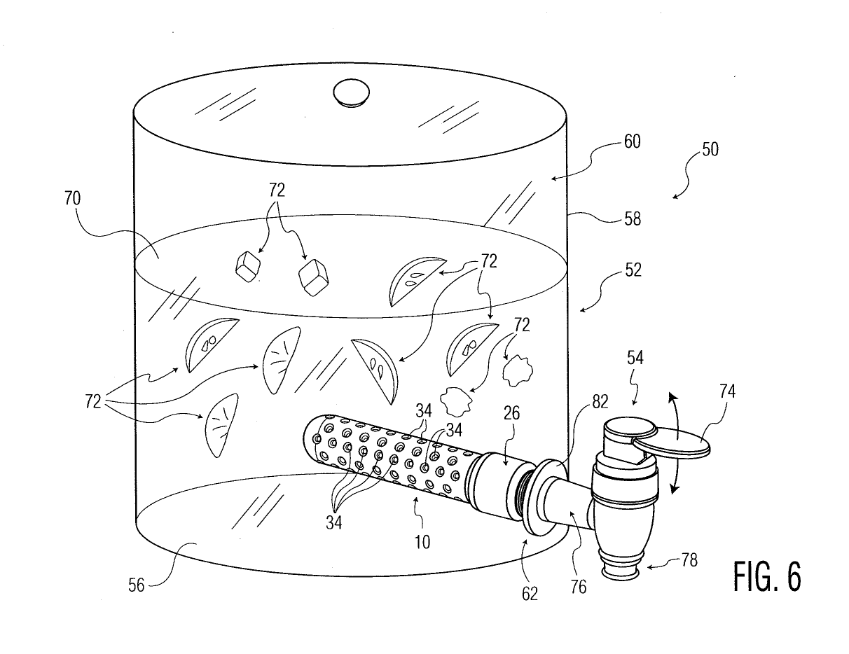

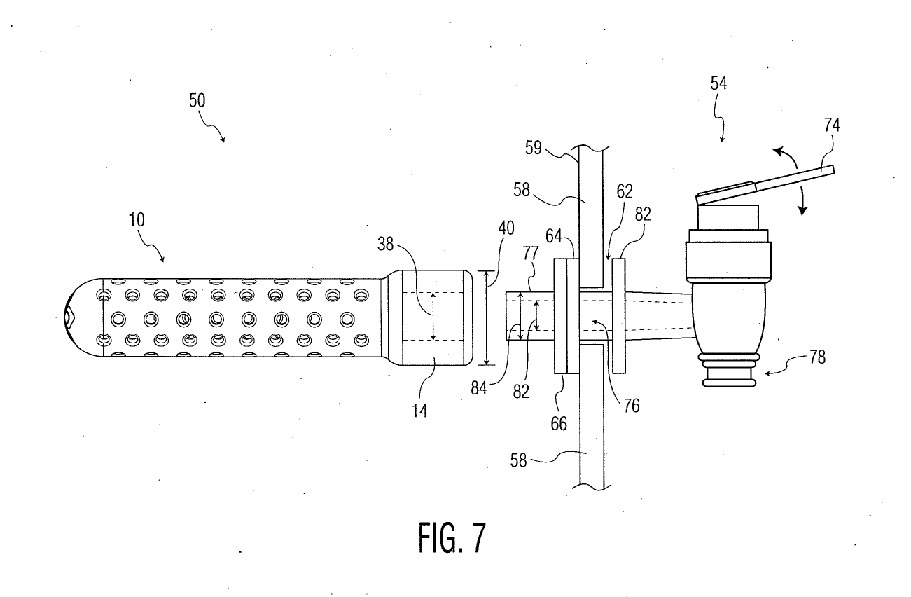

FIG. 6 is a perspective view of an exemplary beverage dispensing system 50 and FIG. 7 is a partially exploded side view of the exemplary beverage dispensing system 50 of FIG. 6. The beverage dispensing system 50 can be a gravity feed dispensing system, although those skilled in the art will recognize that embodiments of the dispenser spigot filter 10 can be used with other types of beverage dispensing systems. As shown in FIGS. 6 and 7, the beverage dispensing system 50 can include an exemplary embodiment of the filter 10, a beverage source, e.g., beverage container 52, and a dispenser spigot 54. Exemplary embodiments can include a kit or article of manufacture that includes components of a beverage dispensing system, such as the beverage dispensing system 50. For example, an exemplary kit can include an embodiment of the dispenser filter 10, a beverage source (e.g., the container 52), and a dispenser spigot (e.g., the dispenser spigot 54), which can be assembled in one or more packages.

The beverage container 52 can have a bottom wall 56 and at least one sidewall 58 defining an interior area 60. An opening 62 can be formed in the sidewall 58 and can receive the dispenser spigot 54 such that the dispenser spigot 54 extends through the opening 62 and into the interior area 60 of the container 52. The dispenser spigot 54 can be secured to the side wall 60 via a seal, e.g., a rubber washer 64 (FIG. 7), and a fastener, e.g., a nut 66, which can threadingly engage the dispenser spigot 54. In some embodiments, the dispenser spigot 52 can be integrally formed with the sidewall 58. In some embodiments, the container 52 can include a top cover 68 that is at least partially removable to facilitate access to the interior area 60 of the container 52, e.g., to fill the container 52 with a beverage 70 that can include objects 72, such as pieces of fruit, vegetables, spices, ice, and/or other objects.

The dispenser spigot 54 can include a dispensing valve (obscured) that can be open and closed by an actuating member 74. The actuating member 74 can be biased to a normally closed position. To open the valve, a user can actuate the actuating member 74 by applying a force to the actuating member 74. When the user releases the actuating member 74, the actuating member 74 can return to its default position to close the valve. In some embodiments, the actuating member 74 can be positioned to selectively lock the valve in the open position until the user applies a force to the actuating member 74 to close the valve. The dispenser spigot 54 can also include a fluid inlet tube 76 projecting longitudinally in a distal direction and an outlet spout 78 extending generally perpendicular to the inlet tube 76. The outlet spout 78 can be positioned at a proximal end of the dispenser spigot 54. The fluid inlet tube 76 can have an inner surface defining an inner diameter 82 and an outer surface defining an outer diameter 84 (FIG. 7). The dispenser spigot 54 can receive a fluid to be outputted by the dispenser spigot 54 via the inlet tube 76 and the valve can be selectively open to dispense the fluid via the outlet spout 78. A flange 82 can be disposed about the inlet tube 76 and positioned towards the proximal end of the inlet tube 76 to seat the dispenser spigot 54 on the side wall 58 of the container 52. The flange 82 can have a larger diameter than a diameter of the opening 62 formed in the sidewall 58 such that the flange 82 cannot pass through the opening 62.

The filter 10 can be secured to the inlet tube 76 of the dispenser spigot 54 by mating the connector portion 26 of the filter 10 with the inlet tube 76 of the dispenser spigot 54. For example, the connector portion 26 can be urged onto the inlet tube 76 by sliding the inner surface 16 of the connector portion 26 over the outer surface 77 of the inlet tube 76 to engage the inlet tube 76 and form a friction fit between the filter 10 and the dispenser spigot 54. For embodiments that are implemented with a resilient flexible material, such as silicone, the inner diameter 38 of the connector portion 26 can be less than or substantially equal to the outer diameter 84 of the inlet tube 76 so that the connector portion 26 is stretched radially outward when the inner surface 16 of the connector portion 26 engages the outer surface 77 of the inlet tube 76. In some embodiments, the friction fit formed by the inner surface of the connector portion 26 and the outer surface 77 of the inlet tube 76 can form a fluid tight seal. The apertures 34 of the filter 10 can generally be smaller than a diameter of the inlet tube 76 and/or the valve opening such that the apertures 34 prevent objects that may clog the dispenser spigot 54 from entering the interior cavity 18 and the inlet tube 76.

In an exemplary embodiment, the inlet tube 76 of the dispenser spigot 54 can be inserted through the opening 62 of the side wall 58 of the container 52 and the dispenser spigot 54 can be fastened to the side wall 58 using the nut 66. The inlet tube 76 can be inserted into through the opening 62 until the flange 82 of the dispenser spigot 54 abuts the side wall 58 to seat the spigot dispenser 54 on the side wall 58. In exemplary embodiments, the rubber washer 64 can be disposed about the inlet tube 76 and between the nut 66 and the inner surface 59 of the side wall 58 such that when the dispenser spigot 54 is fastened to the side wall 58 by the nut 66, a fluid seal is formed between the dispenser spigot 54 and the side wall 58.

The filter 10 can be secured to the inlet tube 76 before or after the inlet tube 76 is inserted through the opening in the side wall 58. Once the filter 10 has been slid over the outer surface 77 of the inlet tube 76 and the dispenser spigot 54 has been attached to the sidewall 58, the interior area 60 can be filled with the beverage 70. The beverage 70 can include objects 72, such as, for example, pieces of fruit, vegetables, spices, and/or ice. As the interior area 60 is filled with the beverage 70, the beverage 70 flows through the apertures 34 into the interior cavity 18 of the filter 10. When the user opens the valve of the dispenser spigot 54, the beverage 70 flows through the apertures 34 in the filter 10 into the interior cavity 18 of the filter 10, and then the beverage 70 in the interior cavity 18 flows through the inlet tube 76 and out of the outlet spout 78. During use of the beverage dispensing system 50, the objects 72 in the beverage 70 can be drawn toward the filter 10 and the apertures 34 of the filter 10 can limit or restrict passage of the objects 72 which are larger than the apertures 34 from the interior area 60 to the interior cavity 18 of the filter 10 so that the objects 72 do not clog the dispenser spigot 54. Objects that fit through the apertures 34 are allowed to pass through the apertures 34 and into the interior cavity 18 of the filter 10. Such objects 72 can be safely passed through the dispenser spigot 54 without clogging the dispenser spigot 54.

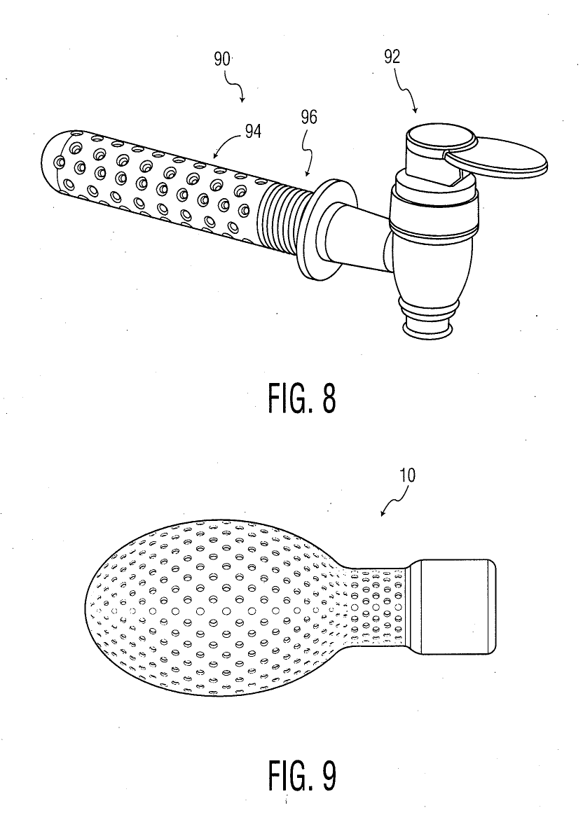

FIG. 8 is an exemplary embodiment of an assembly 90 formed by a spigot dispenser section 92 and a spigot dispenser filter section 94. In the present embodiment, the assembly 90 can be a single, continuous structure such that the inlet tube of the dispenser spigot and the dispenser filter can be a single unitary component. The filter section 94 can include a mating portion 96, e.g., a threaded surface, configured to mate with a fastening member, e.g., a nut, to secure the assembly 90 to a wall of a beverage source, e.g., a container, so that the filter section 94 is disposed within the interior area of the container and the spigot section extends through an opening in the wall of the container and to an exterior of the container. In one embodiment, the spigot dispenser portion 92 can be implemented in a similar manner as an embodiment of the dispenser spigot 54 and the filter section 94 can be implemented in a similar manner as an embodiment of the filter 10. The application and operation of the assembly 90 can be similar to an application and operation of the beverage dispensing system 50.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A dispenser filter for insertion into a beverage container, the dispenser filter comprising:
a body having a beverage filtering portion and an interior cavity, the beverage filtering portion being configured to permit a beverage contained in a beverage container to flow into the interior cavity and to inhibit objects in the beverage from flowing into the interior cavity; and
the body being configured to mate with a dispenser spigot of the beverage dispenser to place the interior cavity in fluid communication with the dispenser spigot to discharge the beverage from the interior cavity of the body.

2. The filter of claim 1, further comprising a connector portion attached to the beverage filtering portion, the connector portion configured to form a friction fit with the dispenser spigot.

3. The filter of claim 1, wherein the filtering portion includes a plurality of apertures and the interior cavity is configured to be in fluid communication with a beverage through the apertures.

4. The filter of claim 3, wherein the apertures are dimensioned to restrict passage of objects in the beverage to the interior cavity.

5. The filter of claim 3, wherein the filtering portion is tubular and the plurality of apertures are distributed radially about a circumference of the filtering portion.

6. The filter of claim 5, wherein the plurality of apertures are arranged in a plurality of rows extending along a longitudinal axis of the filtering portion.

7. The filter of claim 6, wherein the plurality of apertures in first one of the plurality of rows are longitudinally offset from the plurality of apertures in a second adjacent one of the plurality of rows.

8. The filter of claim 1, wherein the body comprises at least one of an elastic, flexible, and semi-rigid material.

9. The filter of claim 1, wherein the body comprises silicone.

10. The filter of claim 1, wherein the connector portion is thicker than the beverage filtering portion.

11. The filter of claim 1, wherein the body further comprises a transition portion positioned between the filtering portion and the connector portion.

12. The filter of claim 11, wherein a thickness of the body increases from the filtering portion to the connector portion through the transition portion.

13. The filter of claim 1, wherein the filtering portion comprises at least one of a tubular, bulbous, rectangular, and ring shape.

14. A beverage dispensing system comprising:
a beverage source having an interior area configured to contain a beverage;
a dispenser configured to dispense the beverage from the beverage source; and
a dispenser filter located in the interior area of the beverage source and in fluid communication with the dispenser, the dispenser filter having an interior cavity in fluid communication with the interior area of the beverage source to collect the beverage in the interior cavity, the dispenser filter having an outlet in fluid communication with the dispenser to discharge the beverage from the interior cavity of the dispenser filter.

15. The system of claim 14, wherein the dispenser filter comprises a body having a beverage filtering portion and a dispenser connector portion, the body defining the interior cavity,
the interior cavity of the body being in fluid communication with the beverage source through the beverage filtering portion,
the beverage filtering portion being configured to permit a beverage to flow into the interior cavity from the beverage source and to inhibit objects in the beverage from flowing into the interior cavity, and
the dispenser connector portion being configured to mate with the dispenser to place the interior cavity in fluid communication with the dispenser spigot to discharge the beverage from the interior cavity of the body.

16. The system of claim 15, wherein the connector portion is configured to form a friction fit with the dispenser spigot.

17. The system of claim 15, wherein the filtering portion includes a plurality of apertures and the interior cavity is configured to be in fluid communication with the beverage source through the apertures.

18. The filter of claim 17, wherein the apertures are dimensioned to restrict passage of objects from the beverage source to the interior cavity.

19. A method of filtering a beverage being dispensed from a beverage container, the method comprising:
mating a dispenser filter with a dispenser spigot in an interior area of a beverage source configured to contain a beverage, the dispenser filter having an interior cavity in fluid communication with the interior area of the beverage source and in fluid communication with the dispenser spigot;
filling the interior of the beverage source with a beverage;
collecting the beverage in the interior cavity of the spigot dispenser filter;
inhibiting objects in the beverage from passing from the interior area to the interior cavity; and
dispensing the beverage collected in the interior cavity through an outlet spout of the spigot dispenser filter.

20. A dispenser assembly for a beverage dispensing system comprising:
a dispenser spigot section having an actuating member and an outlet spout; and
a beverage filtering section having a body defining an interior cavity, the body having a plurality of apertures, the interior cavity being in fluid communication with a beverage source through the plurality of apertures to permit a beverage of the beverage source to flow through the plurality of apertures into the interior cavity and to inhibit objects in the beverage from flowing into the interior cavity,
wherein the beverage filtering section is integrally formed with the dispenser spigot and the actuating member is moveable to selectively dispense the beverage from the interior cavity of the beverage filtering section.

21. A kit comprising:
a container defining an interior area;
a dispenser spigot configured to be in fluid communication with the interior area; and
a dispenser filter configured to be disposed in the interior area of the container and secured to the dispenser spigot, the dispenser filter comprising a body defining an interior cavity to be in fluid communication with the interior area of the container, to permit a beverage in the interior area to flow into the interior cavity, to inhibit objects in the beverage from flowing into the interior cavity, and to discharge the beverage from the interior cavity through the dispenser spigot.
